(19) United States
(12) Patent Application Publication
(10) Pub. No.: US 2025/0119859 A1
(43) Pub. Date: Apr. 10, 2025

(54) REGISTERING WITH MULTIPLE NETWORKS

(71) Applicant: Lenovo (Singapore) Pte. Ltd., New Tech Park (SG)

(72) Inventors: Genadi Velev, Darmstadt (DE); Apostolis Salkintzis, Athens (GR)

(21) Appl. No.: 18/833,231

(22) PCT Filed: Mar. 3, 2022
(86) PCT No.: PCT/EP2022/055492

§ 371 Date: Jul. 25, 2024

(30) Foreign Application Priority Data
Jan. 26, 2022 (GR) 20220100069

(51) Int. Cl. H04W 60/00

(52) U.S. Cl. CPC H04W 60/00

(57) ABSTRACT

Apparatuses, methods, and systems are disclosed for registering with multiple networks. One method includes receiving, at a first network function, a first request message from a second NF in a second network. The first request includes a registration request for a user equipment (UE). The method includes receiving a second request message from a third NF in a third network. The second request includes an indication for an additional registration for the UE. The method includes determining to accept the registration requests from the second network and the third network for the UE. The method includes transmitting a first indication to the second NF and the third NF. The first indication includes a request for notifications about network slices to which the UE is currently registered.

### FIELD

The subject matter disclosed herein relates generally to wireless communications and more particularly relates to registering with multiple networks.

### BACKGROUND

In certain wireless communications networks, a UE may use two different network slices simultaneously. In such networks, a single network may not provide the two different network slices.

### BRIEF SUMMARY

Methods for registering with multiple networks are disclosed. Apparatuses and systems also perform the functions of the methods. One embodiment of a method includes receiving, at a first network function, a first request message from a second NF in a second network. The first request includes a registration request for a user equipment (UE). In some embodiments, the method includes receiving a second request message from a third NF in a third network. The second request includes an indication for an additional registration for the UE. In certain embodiments, the method includes determining to accept the registration requests from the second network and the third network for the UE. In various embodiments, the method includes transmitting a first indication to the second NF and the third NF. The first indication includes a request for notifications about network slices to which the UE is currently registered.

One apparatus for registering with multiple networks includes a first network function. In some embodiments, the apparatus includes a receiver that: receives a first request message from a second NF in a second network, wherein the first request includes a registration request for a user equipment (UE); and receives a second request message from a third NF in a third network. The second request includes an indication for an additional registration for the UE. In various embodiments, the apparatus includes a processor that determines to accept the registration requests from the second network and the third network for the UE. In certain embodiments, the apparatus includes a transmitter that transmits a first indication to the second NF and the third NF. The first indication includes a request for notifications about network slices to which the UE is currently registered.

Another embodiment of a method for registering with multiple networks includes storing, at a device, configuration information that allows simultaneous registration with multiple networks or an association between network slices supported in a second network and in a third network. In some embodiments, the method includes registering with the second network. In certain embodiments, the method includes transmitting a registration request message for registering with the third network. The registration request message includes an indication that the registration with the third network is an additional registration. In various embodiments, the method includes receiving a message from the second network or the third network. The message includes an indication about service restrictions.

Another apparatus for registering with multiple networks includes a device. In some embodiments, the apparatus includes a processor that: stores configuration information that allows simultaneous registration with multiple networks or an association between network slices supported in a second network and in a third network; and registers with the second network. In various embodiments, the apparatus includes a transmitter that transmits a registration request message for registering with the third network. The registration request message includes an indication that the registration with the third network is an additional registration. In certain embodiments, the apparatus includes a receiver that receives a message from the second network or the third network. The message includes an indication about service restrictions.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for registering with multiple networks;

FIG. 2 is a schematic block diagram illustrating one embodiment of an apparatus that may be used for registering with multiple networks;

FIG. 3 is a schematic block diagram illustrating one embodiment of an apparatus that may be used for registering with multiple networks;

FIGS. 4A and 4B are a schematic block diagram illustrating one embodiment of a system showing signaling flow for a UE registered simultaneously to multiple networks;

FIG. 5 is a flow chart diagram illustrating one embodiment of a method for registering with multiple networks; and

FIG. 6 is a flow chart diagram illustrating another embodiment of a method for registering with multiple networks.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

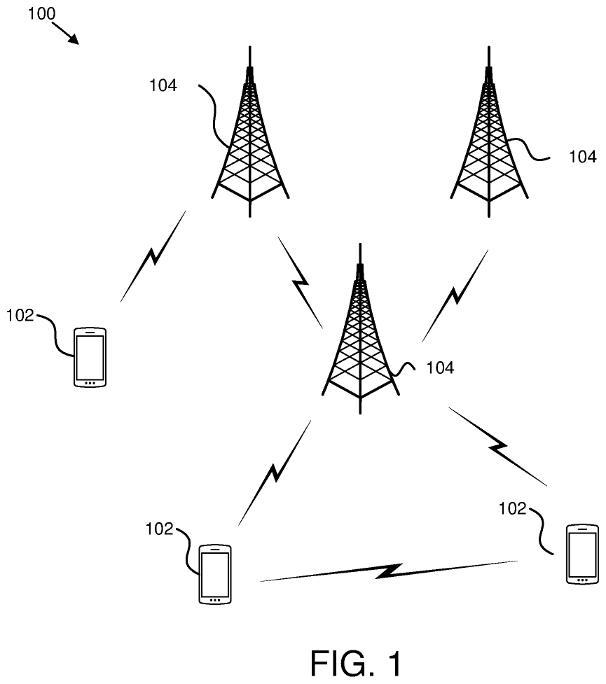

FIG. 1 depicts an embodiment of a wireless communication system 100 for registering with multiple networks. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, at a first network function, a first request message from a second NF in a second network. The first request includes a registration request for a user equipment (UE). In some embodiments, the network unit 104 may receive a second request message from a third NF in a third network. The second request includes an indication for an additional registration for the UE. In certain embodiments, the network unit 104 may determine to accept the registration requests from the second network and the third network for the UE. In various embodiments, the network unit 104 may transmit a first indication to the second NF and the third NF. The first indication includes a request for notifications about network slices to which the UE is currently registered. Accordingly, the network unit 104 may be used for registering with multiple networks.

In certain embodiments, a remote unit 102 may store, at a device, configuration information that allows simultaneous registration with multiple networks or an association between network slices supported in a second network and in a third network. In some embodiments, the remote unit 102 may register with the second network. In certain embodiments, the remote unit 102 may transmit a registration request message for registering with the third network. The registration request message includes an indication that the registration with the third network is an additional registration. In various embodiments, the remote unit 102 may receive a message from the second network or the third network. The message includes an indication about service restrictions. Accordingly, the remote unit 102 may be used for registering with multiple networks.

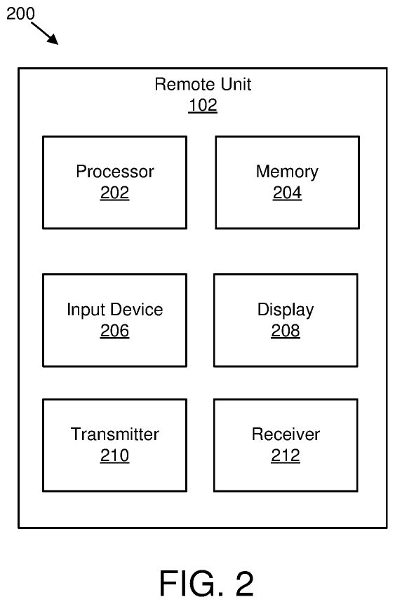

FIG. 2 depicts one embodiment of an apparatus 200 that may be used for registering with multiple networks. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202: stores configuration information that allows simultaneous registration with multiple networks or an association between network slices supported in a second network and in a third network; and registers with the second network. In various embodiments, the transmitter 210 transmits a registration request message for registering with the third network. The registration request message includes an indication that the registration with the third network is an additional registration. In certain embodiments, the receiver 212 receives a message from the second network or the third network. The message includes an indication about service restrictions.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

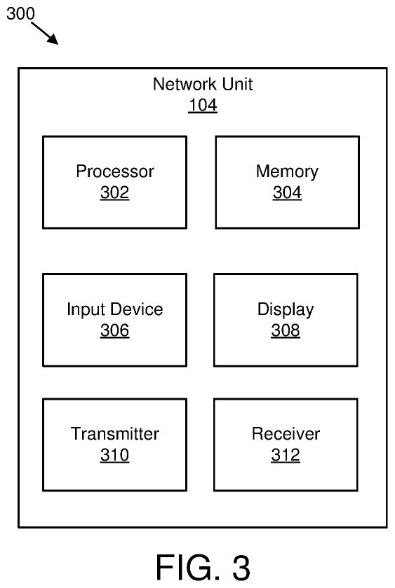

FIG. 3 depicts one embodiment of an apparatus 300 that may be used for registering with multiple networks. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312: receives a first request message from a second NF in a second network, wherein the first request includes a registration request for a user equipment (UE); and receives a second request message from a third NF in a third network. The second request includes an indication for an additional registration for the UE. In various embodiments, the processor 302 determines to accept the registration requests from the second network and the third network for the UE. In certain embodiments, the transmitter 310 transmits a first indication to the second NF and the third NF. The first indication includes a request for notifications about network slices to which the UE is currently registered.

In certain embodiments, a fifth generation (“5G”) communication system (“5G System”, “5GS”) may support network slicing. Moreover, a network slice is an independent (e.g., virtualized) logical network on a physical network infrastructure. Thus, a network slice may be a logical network that includes a set of network functions and corresponding resources (e.g., computing, storage, networking) necessary to provide certain network capabilities and network characteristics. Further, a network slice may include a core network (“5G core network”, “5GC”) with control plane and user plane network functions (“NFs”) and an access network (e.g., 5G radio access network or fixed access network).

In some embodiments, a user equipment (“UE”) may be configured with network slice relevant information, which may be referred to as network slice selection assistance information (“NSSAI”). Moreover, the NSSAI may include one or more single (“S”) NSSAIs (“S-NSSAIs”). The network slice may be identified in the network and in the UE by an S-NSSAI.

In various embodiments, a UE may be subscribed to use multiple network slices. If the slices are available in the same location and/or area, the UE may use the network slices simultaneously. This may be valid in the home network (e.g., the network with which the UE has the subscription). The home operator may have agreements with other operators to support the same slices for roaming UEs. It may happen that the most preferred (e.g., first) visiting public land mobile network (“PLMN”) (“VPLMN”) in a foreign area does not support all the network slices to which the UE is subscribed. There may be no single VPLMN is the foreign area supporting all the subscribed network slices. Further, there may be a second VPLMN which supports the slices not available in the most preferred VPLMN. In this case, a home PLMN (“HPLMN”) may need to configure the UE with necessary information to use the second VPLMN to obtain the service(s) supported by or associated with that network slice. If the UE wants to use the service(s) associated with multiple network slices simultaneously in roaming scenario, there may be the need to register with the first and second VPLMNs simultaneously.

In certain embodiments, a UE implements certain capabilities allowing the UE to connect to more than one PLMN simultaneously.

In some embodiments, a UE may use two different network slices simultaneously. If the UE is registered with a home network (e.g., HPLMN), the UE may use two network slices simultaneously. However, if the UE is roaming, there may not be a single VPLMN which can serve both network slices. In roaming scenarios, the UE may use a first network slice in a first VPLMN and a second network slice in a second VPLMN.

In various embodiments, if a UE is roaming (e.g., roaming to a network located in a foreign country compared the country of the HPLMN, or roaming to network in the same country as the HPLMN) there may not be a single network which is able to serve all of the subscribed network slices (e.g., list of subscribed S-NSSAIs for the UE). In such embodiments, the UE may use one subset of subscribed S-NSSAIs in one network (e.g., first VPLMN, first stand-alone non-public network “SNPN”) and another subset of the subscribed S-NSSAIs in another network (e.g., second VPLMN, second SNPN).

In certain embodiments, for UEs that have the ability to obtain service from more than one VPLMN simultaneously, the following may apply: 1) if a roaming UE with a single PLMN subscription requires simultaneous access to multiple network slices and the network slices are not available in a single VPLMN, the 5G system may enable the UE to: a) be registered to more than one VPLMN simultaneously, and b) use network slices from more than one VPLMN simultaneously; 2) the HPLMN may be able to authorize a roaming UE with a single PLMN subscription to be registered to more than one VPLMN simultaneously to access network slices of those VPLMNs; and/or 3) the HPLMN may be able to provide a UE with permission and prioritization information of the VPLMNs the UE is authorized to register to use specific network slices.

In some embodiments, a home network (e.g., HPLMN) may maintain multiple visited networks (e.g., VPLMNs, SNPNs) registrations over the same access technology (e.g., over 3GPP or non-3GPP access). Furthermore, a home network may know to which network slices the UE is registered (e.g., currently registered) in each of the multiple visited networks.

In various embodiments, if a UE performs a registration to a network (e.g., 5GS), the UE includes one of the following registration types: 1) initial registration: if a UE registers for the first time with a PLMN; 2) mobility registration update (“MRU”): if a UE is already registered with a PLMN and updates the registration; 3) emergency: if a UE is in a limited service state and wants to initiate an emergency service; 4) SNPN onboarding: if a UE wants to register to gain provisioning (or onboarding) for an SNPN; and 5) disaster roaming: if a UE wants to register with a network that is not in the list of allowed networks and due to disaster conditions.

In certain embodiments, there may be two procedures for a UE which may maintain more than one simultaneous registration with a network. In one procedure, during an evolved packet system (“EPS”) to 5GS interworking procedure, the UE may include a specific informational element (“IE”) in an attach or registration request message to indicate to a mobile management entity (“MME”) or AMF that the UE moves between core networks of the same PLMN (e.g., UE indicates that it is moving from 5GC)—the UE may simultaneously register with both EPS and 5GS systems which is known as dual-registration mode: a) in dual-registration mode, the UE handles independent registrations for 5GC and evolved packet core (“EPC”) using separate radio resource control (“RRC”) connections—in this mode, the UE maintains a 5G global unique temporary identifier (“GUTI”) (“5G-GUTI”) and EPS GUTI (“EPS-GUTI”) independently—in this mode, the UE provides native 5G-GUTI, if previously allocated by 5GC, for registrations towards 5GC and it provides native EPS-GUTI, if previously allocated by EPC, for attach and/or tracking area update (“TAU”) towards EPC—in this mode, the UE may be registered to 5GC only, EPC only, or to both 5GC and EPC, b) dual-registration mode is intended for interworking between EPS and/or evolved (“E”) universal terrestrial radio access network (“UTRAN”) (“E-UTRAN”) and 5GS and/or NR-a dual-registered UE should not send its E universal terrestrial radio access (“UTRA”) (“E-UTRA”) connected to 5GC and E-UTRAN radio capabilities to NR access when connected to 5GS and/or NR to avoid being handed over to 5GC-connected E-UTRA or to E-UTRAN—this shows that the UE registers via different access technologies to different core network types, however, the UE may register to more than one network via the same access technology and to the same core network type—the network supporting dual-registration mode also supports a combo node called home subscriber server (“HSS”)+UDM which maintains the registrations in EPC and 5GC.

In a second procedure, the UE can register simultaneously via 3GPP access and non-3GPP access with the same or different networks: a) if the UE registers over both 3GPP and non-3GPP access with the same network, then the same AMF serves both UE registrations—the AMF associates both registration context and assigns 5G-GUTI that is common to both 3GPP and Non-3GPP accesses, and b) if the UE registers over both 3GPP and Non-3GPP access over different network (e.g., in roaming case if there is no available network supporting both access types), the UE is able to handle two separate registrations including two 5G-GUTIs, one per PLMN, and two associated equivalent PLMN lists.

In some embodiments, a UE may use the same access technology, and, therefore, a UDM overwrites a first registration (e.g., initiated from a first AMF) if the UDM receives a second registration request (e.g., from a second AMF). In other words, the UDM may not differentiate that the request for first registration and the request for the second registration are to be used concurrently. The reason for not being able to differentiate is because a second registration request with the same access type as the existing registration entry would overwrite the existing registration entry.

In various embodiments, a home network (e.g., HPLMN, SNPN, or credential holder (“CH”)) may maintain multiple UE registrations over multiple networks over the same access technology (e.g., over 3GPP access or non-3GPP access) or over different access technologies. A UE may attempt registration to multiple networks, and the networks can be one of: 1) multiple visited networks (e.g., VPLMNs, visited SNPNs); and 2) at least one visited network (e.g., VPLMNs, visited SNPN) and a home network (e.g., HPLMN, home SNPN).

In certain embodiments: 1) if a UE registers to an additional network, the UE sends to the network (e.g., the AMF) an indication for an additional registration during the registration procedure-if the AMF receives the indication for additional registration, the AMF sends to the UDM the indication for additional registration (e.g., if the AMF registers itself as serving NF with the UDM); 2) based on the indication for additional registration type, the UDM determines to not cancel the old UE registration, but instead to create a new registration entry for the UE (e.g., a new registration associated with the radio access technology indicated by the AMF, which might be the same RAT or AT as the existing entry)—the UDM is able to maintain multiple registrations for the same UE with different networks; 3) the UDM requests that the AMFs to which the UE is registered report the network slices to which the UE is currently registered—the UDM receives and maintains an association of which AMF has registered with which network slices for the UE—the UDM may also request and/or receive on demand which S-NSSAIs are supported (or not supported) in the current UE registration area or in the whole network (e.g., to which the UE is registered); and 4) the UDM is able to determine which services are allowed to be used (or not used) in each of the networks where the UE is registered.

In some embodiments, a UE may be subscribed to use multiple services which are offered via multiple network slices. The network slice is identified by S-NSSAI. These multiple services or multiple network slices may be simultaneously supported in the home network. To support scenarios, where, in some geographical locations and/or regions, the available networks (e.g., VPLMNs or visited SNPNs) do not simultaneously support all subscribed services or network slices of the UE, the UE may be allowed (e.g., authorized) to register with multiple networks. In other words, the available visited networks support a sub-set of the UE's subscribed services or network slices.

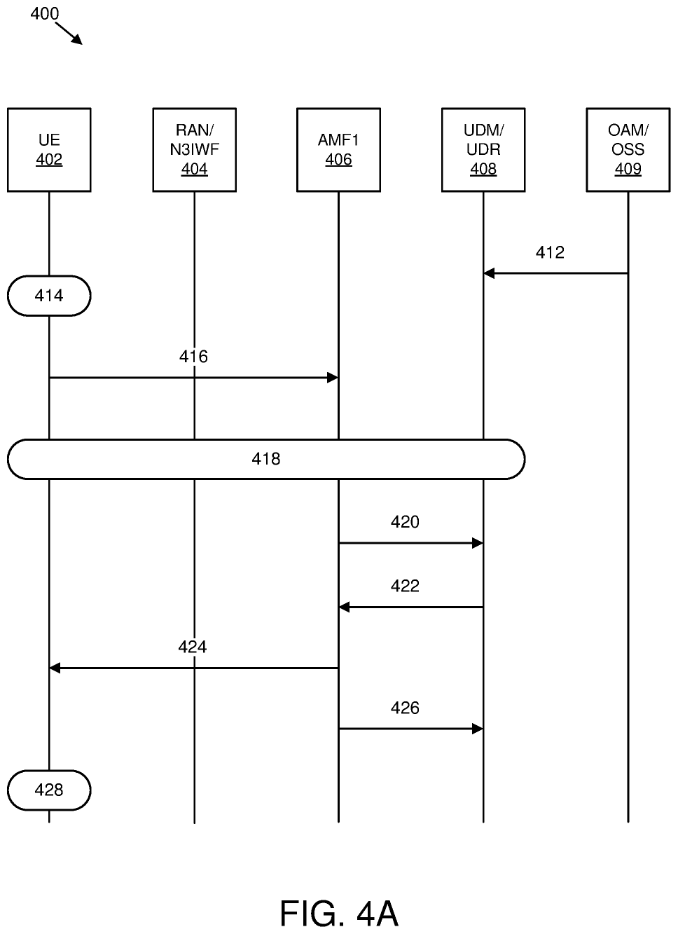

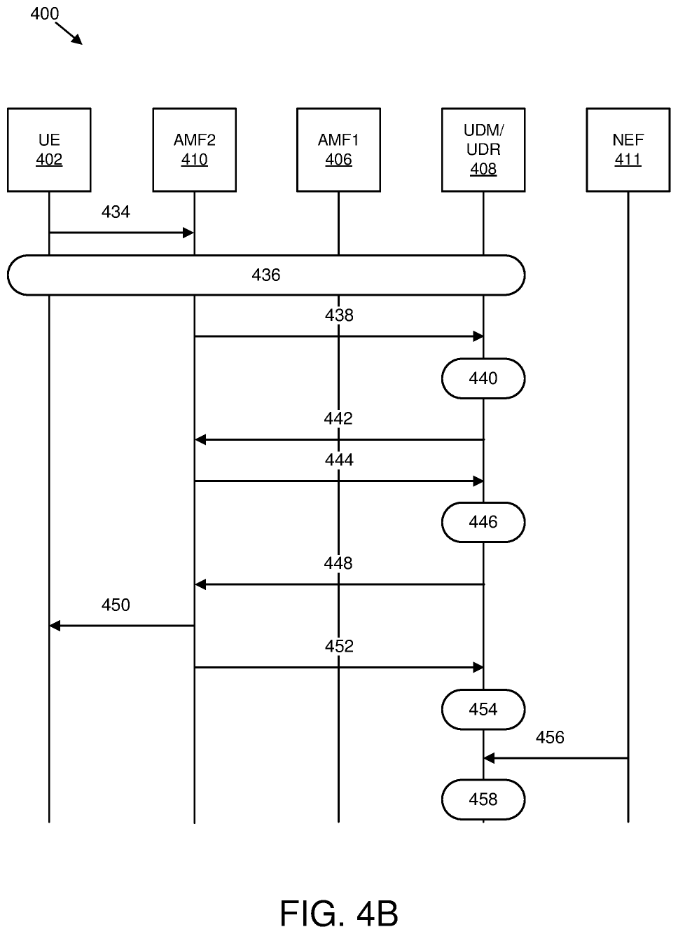

FIGS. 4A and 4B are a schematic block diagram illustrating one embodiment of a system 400 showing signaling flow for a UE registered simultaneously to multiple networks. The system 400 includes a UE 402, a RAN/N3IWF/TNGF 404 (e.g., RAN and/or non-3GPP interworking function (“N3IWF”)), an AMF1 406 (e.g., the RAN/N3IWF/TNGF 404 and the AMF1 406 may be part of a first network, VPLMN1), a UDM/UDR 408 (e.g., UDM and/or UDR), an OAM/OSS 409 (e.g., OAM and/or operations support system (“OSS”)) (e.g., the UDM/UDR 409 and the OAM/OSS 409 may be part of a home network, HPLMN), an AMF2 410 (e.g., part of a second network, VPLMN2), and a network exposure function (“NEF”) 411. Each of the illustrated communications may include one or more messages.

In a first communication 412, the home network (e.g., UDM/UDR 408 in the HPLMN's 5GC) is configured (e.g., via the OAM/OSS 409 according to the UE subscription and service level agreements with roaming partners) with information indicating that the UE 402 is allowed (e.g., authorized) to register with multiple networks for the purpose of using different services and/or network slices via the different networks. In other words, if the UE 402 wishes to use services or network slices which are not supported by a single available network, the UE 402 may determine (e.g., based on configuration) to register with different networks where the desired services or network slices are supported. Moreover, the home network (e.g., UDM/UDR 408 in the HPLMN's 5GC) may be configured with information that some network slice (e.g., S-NSSAIs) may be supported in a specific network only. For example, S-NSSAI1 is available in certain VPLMNs and/or SNPNs only, and S-NSSAI2 is available in certain other VPLMNs and/or SNPNs.

The UE 402 may be pre-configured with one or more of the following information: 1) slice-based network selection information; or 2) authorization for simultaneous network registration. The slice-based network selection information (e.g., operator controlled slice-based selector where mapping information of the supported S-NSSAIs is included) allows the UE 402 to perform network selection depending on the preferred (or desired) services or network slices which the UE intends to use. This may be referred as “slice-based network selection configuration” and may be associated with a configuration version identifier (“ID”). In addition, the UE 402 may be configured with “authorization for simultaneous network registration” which means whether the UE 402 is allowed to register to multiple networks (e.g., VPLMNs or SNPNs) simultaneously. Further, this configuration may include a list of networks which are allowed to be used in simultaneous registrations (e.g., the UE 402 is allowed to initiate simultaneous registrations only to the networks which are included in this list). Both configurations can be stored 414 in the UE's universal subscriber identity module (“USIM”) profile, or in the ME part of the UE 402 (e.g., in non-volatile memory, so that the information is stored even when the UE is switched off). In the latter case, the UE 402 may have been configured via a control plane (e.g., non-access stratum (“NAS”) protocol by the AMF or UE parameter update procedure by the UDM).

In a second communication 416, the UE 402 selects the first network (e.g., visiting public land mobile network (“PLMN”) (“VPLMN”), SNPN, HPLMN) according to a network selection procedure whereby the slice-based network selection information may be used. The UE 402 performs a registration procedure (e.g., NAS registration request) with the first network by sending a registration request message. The UE 402 may include a requested NSSAI, a subscription concealed identifier (“SUCI”), and/or a RegType-initial indication.

In a third communication 418, the AMF1 406 triggers primary authentication and authorization for the first network, if needed (e.g., there is no valid UE 402 security context in the AMF1 406), where the AUSF and the UDM (or optionally an authentication authorization accounting (“AAA”) server in case of CH) are included in the authentication procedure.

In a fourth communication 420, the AMF1 406 selects an UDM for the UE 402, sends a request to register the AMF1 406 as a serving AMF for the UE 402 and also sends a request to download and/or retrieve the UE 402 subscription data. The AMF1 406 may invoke the service operation Nudm_UECM_Registration to register itself as serving AMF for the UE 402 and the Nudm_SDM_Get to retrieve the UE 402 subscription data. The AMF1 406 includes the UE ID (e.g., subscriber ID, subscription permanent identifier (“SUPI”)), the AMF1 ID (e.g., first globally unique AMF ID (“GUAMI1”)), the access type (“AT”), the registration type “initial” and/or a further parameter.

In a fifth communication 422, the UDM/UDR 408 sends to the AMF1 406 the UE 402 subscription data for access and mobility management which contains a list of the subscribed S-NSSAIs and further subscription parameters (e.g., this may also be triggered in a different step, such as when the UE 402 registers over multiple AMFs). Optionally, or in addition, the UDM/UDR 408 may send a request indication to the AMF1 406 to report to which S-NSSAIs (e.g., out of the full list of subscribed S-NSSAIs) the UE 402 is currently registered. It should be noted that, according to a service level agreement (“SLA”) between HPLMN and VPLMN1, the first network (VPLMN1) is supposed to support all subscribed S-NSSAIs, but due to some network conditions or network reconfiguration, some S-NSSAIs may not be supported (e.g., not supported temporarily or not supported in the particular geographic area). Therefore, may be beneficial for the AMF1 406 to be able to indicate the unsupported S-NSSAIs to the home network (e.g., UDM), and in addition may indicate the reason for non-support (e.g., time duration or geographic area). The UDM/UDR 408 may request that the AMF1 406 report the S-NSSAIs (e.g., per access type) to which the UE 402 is registered in the first network. For example, the UDM/UDR 408 may include a new request indication in the response for UE 402 subscription data; or alternatively the UDM/UDR 408 may invoke the service operation Nudm_SDM_Notification including a request to report the currently registered network slices per access type. In some embodiments, the UDM/UDR 408 creates a registration entry and/or context for the UE 402 associated with the AMF1 406 (e.g., first network) and the used access type.

In a sixth communication 424, the first network (e.g., AMF1 406) completes the registration procedure by sending a registration accept message to the UE 402. This creates a valid registration context in the UE 402 and in the AMF1 406, which includes context for security, access and mobility management, exchanged capabilities, supported services, and so forth. The UE 402 is configured for network slicing and allowed services. For example, the network may send to the UE 402 a configured NSSAI for the first network (VPLMN1), allowed NSSAI and rejected NSSAI for the registration area in the first network. Based on the received information (e.g., configured NSSAI for the first network, allowed NSSAI, rejected NSSAI) or non-supported slices in the first network, the UE 402 determines which S-NSSAIs are supported in the first network, or which S-NSSAIs are not supported but supported in another network in the same area. If the UE 402 wants to use slices not supported in the first network but supported in another network in the same area, the UE 402 may perform a new network selection procedure and attempt to register with the other network (e.g., either using an additional registration, or switching to the other network). It should be noted that “same area” means in the same country, in the same geographical region, or the same location. The location may mean the area where the UE 402 is currently registered.

In a seventh communication 426, the AMF1 406 sends a notification (or reply message) including a list of registered S-NSSAIs (e.g., corresponding to the stored allowed NSSAI in the UE 402 context in AMF1 406) for the access type used by the UE. For example, the AMF1 406 may invoke the service operation Nudm_SDM_Info including the registered S-NSSAIs (e.g., S-NSSAI1, S-NSSAI3) per access type, a GUAMI1, and/or a SUPI, which basically correspond to the allowed NSSAI for the access type.

The UE 402 may determine 428 to perform a network selection procedure if: 1) the UE 402 wishes to use additional services or network slices, which are not supported in the first network; and 2) the UE 402 is configured and authorized. For example, if the UE 402 is authorized to simultaneously register with multiple network due to use of different services or network slices and the slice-based network selection information is stored, the UE 402 may trigger network selection procedure considering the preferred (e.g., desired) service or network slices (e.g., the UE 402 selects a network which supports the preferred (e.g., desired) service or network slices). As a result, the UE 402 may select the second network.

In an eighth communication 434, the UE 402 performs a registration procedure with the second network (e.g., VPLMN2) by sending a registration request message. The UE 402 includes an indication that this is an additional (initial) registration, which means that the UE 402 intends to keep the existing registration (e.g., with the first network) and register with the second network in addition. In other words, the UE 402 determines to send a registration request type of “additional registration” if the UE 402 is already registered within one network and attempts to register with a second network, whereas the registration with the first network may be retained. The UE may use the “additional registration” registration type if the second registration with VPLMN2 is over the same access type as the existing first registration with VPLMN1.

In a nineth communication 436, the AMF2 410 triggers primary authentication and authentication for the second network, if needed (e.g., there is no valid UE 402 security context in the AMF2 410). The AMF2 410 may indicate to the AUSF that this an authentication for additional primary authentication so that the AUSF is aware to not release (i.e., remove or delete) the association with the security context maintained for the AMF1 806, if any.

In a tenth communication 438, the AMF2 410 selects the UDM/UDR 408 for the UE 402 and sends a request to register the AMF2 410 as the serving AMF for the UE 402. The AMF2 410 may select the same UDM/UDR 408 which was already in use for this UE 402 (e.g., the same UDM/UDR 408 selected by the AMF1 406). The AMF2 410 may include its AMF ID (e.g., second globally unique AMF ID (“GUAMI2”)), the UE's SUPI, access type (e.g., AT, 3GPP access or non-3GPP access) via which the UE 402 has requested the registration, radio access technology (“RAT”) used currently (e.g. NR), registration type set to additional (e.g., RegType=additional), and other parameters. In other words, the AMF2 410 sends to the UDM/UDR 408 a request indicating an additional registration, since the UE has indicated an additional registration type in the registration request message. The AMF2 410 may include information about the supported services by the UE 402 and by the AMF2 410 (e.g., internet protocol (“IP”) multimedia subsystem (“IMS”) or single radio voice call continuity (“SRVCC”) support).

Since the UDM/UDR 408 may already has a registration entry associated with the UE's SUPI and GUAMI1 of the AMF1 406 (and optionally or alternatively based on the different mobile network codes (“MNCs”) part of the GUAMI) and the GUAMI2 value is different from the GUAMI1 value and based on the indication of registration type “additional,” the UDM/UDR 408 determines 440 that the UE 402 attempts to register with the AMF2 410 (e.g., second network) in addition to the existing registration to the AMF1 406 (e.g., the first network). If the UDM/UDR 408 receives a registration type set to additional but there is no registration entry for the SUPI, the UDM/UDR 408 may perform a check with other UDM/UDR instances to verify whether the first and/or initial UE 402 registration is in another UDM/UDR. If yes, the UDM/UDR 408 may attempt to have both registration entries in the same UDM (e.g., the UDM/UDR 408 may re-route the request from the AMF2 410 to the other UDM which already stores registration entry for the UE 402. In certain embodiments, the UDM/UDR 408 determines whether to accept the additional registration based on the internal policies, UE capabilities, UE subscription data plan, and so forth. If the UDM/UDR 408 accepts the additional registration from the AMF2 410, the UDM/UDR 408 keeps the UE 402 registration entry (or context) associated with the AMF1 406 (e.g., GUAMI2) and creates a new registration entry (or context) associated with the AMF2 410 (e.g., GUAMI2). In other words, if the UDM/UDR 408 determines to accept the registration request from the AMF2 410, the UDM/UDR 408 will maintain two simultaneous registrations each associated with a different AMF ID (e.g., at different networks) for the UE 402 and possibly for the same access type and access technology.

In some embodiments, if the UDM/UDR 408 determines that the UE 402 is not allowed to register simultaneously to different networks, the UDM/UDR 408 may reject the request from the AMF2 410 with an appropriate reject cause meaning that simultaneous registrations are not allowed. If instead of an “additional registration” type the message includes an “initial” or “mobility registration” type, the UDM/UDR 408 may overwrite the existing registration entry created by the AMF1 406. The included AT value and RAT value may be the same or different from the existing registration entry from the AMF1 406.

In an eleventh communication 442, the UDM/UDR 408 sends a response message to the AMF2 410 with the result of the registration. If the UDM/UDR 408 determines that the UE 402 is allowed to register simultaneously to different AMFs and/or networks, the UDM/UDR 408 indicates a positive result. In various embodiments, if the UDM/UDR 408 determines that the UE 402 is not allowed to register simultaneously to different networks, the UDM/UDR 408 may include a rejection due to unauthorized registration to multiple networks simultaneously. In certain embodiments, the AMF2 410 may send a registration reject message to the UE 402 with the reject cause similar to the reject cause received from the UDM/UDR 408. The UE 402 may store the reject cause and determine to not initiate new registration with additional registration type. In other words, the UE 402 may overwrite the previously configured authorization to use simultaneous registration.

In a twelfth communication 444, the AMF2 410 sends a request for subscription data retrieval (e.g., UE subscription data). For example, the AMF2 410 may use a Nudm_SDM_Get service operation.

The UDM/UDR 408 determines 446 which UE 402 subscription data to be provided to the AMF2 410. In addition, the UDM/UDR 408 may determine to maintain the registered S-NSSAIs in each AMF (e.g., since there are multiple simultaneous registrations associated with different AMFs for the same UE 402). The UDM/UDR 408 sends a request indication to the AMF2 410 to request the network slices to which the UE 402 is currently registered (e.g., the indication may be called “request for registered and/or allowed network slices”). If the UDM/UDR 408 hasn't sent the “request for registered and/or allowed network slices” to the AMF1 406, the UDM/UDR 408 sends the “request for registered and/or allowed network slices” to the AMF1 406. Moreover, the UDM/UDR 408 determines which subscribed slices are to be sent to the AMF2 410 (e.g., S-NSSAI1 (or S-NSSAI1 and S-NSSAI2) based on internal configuration or based on on-demand information received from the AMF2 410).

In certain embodiments, the home network (e.g., UDM/UDR 408) determines which services (e.g., short message service (“SMS”), location services (“LCS”), proximity services (“ProSe”), IMS, and so forth) are allowed to be used in the second network, considering also the registration in the first network. The service enablement in a particular network out of multiple networks (or single registration entry when multiple registration entries are available) is beneficial, as otherwise there may be conflicts. For example, for SMS service, the SMS function (“SMSF”) in the serving (and/or visited network) registers with the corresponding NF, e.g., SMS-GMSC (Gateway Mobile Switching Center), inter working mobile switching center (“IWMSC”), and/or SMS router or IP session management (“SM”) gateway (“GW”) (“IP-SM-GW”) in the home network (e.g., HPLMN). If the AMF1 406 and the AMF2 410 are located in different visited networks and each AMF select a different SMSF (e.g., SMSF1 in VPLMN1 and SMSF2 in VPLMN2), then the further registration with the SMS-GMSC (“SMS-GMSC”), IWMSC, SMS Router, and/or IP-SM-GW may become cumbersome. The SMS-GMSC, IWMSC, SMS Router or IP-SM-GW may not be able to maintain registration to multiple SMSFs. Therefore, the UDM/UDR 408 may determine that the SMS service is used only in a single AMF (or a single network) if the UE 402 is registered simultaneously with multiple AMFs in different networks. The UDM/UDR may determine that a specific service is used via a specific network based in local configuration or based on service agreements with each of the networks, to which the UE is currently registered. If a UE, which is registered to first and second networks, deregisters from the first network, in which a specific service is allowed, the UDM/UDR may determine to send a notification to the second network to enable the specific service in the second network.

In some embodiments, the home network (e.g., UDM/UDR 408) may decide the service restrictions (e.g., which service is allowed or not allowed in a particular network) by also considering the network slices to which the UE 402 is registered in each network. For example, if the UE 402 registers to an enhanced mobile broadband (“eMBB”) network slice which offers an IMS service over the first network, then the UDM/UDR 408 may determine to allow the IMS over the first network. Thus, the UDM/UDR 408 would not send IMS subscription data to the AMF2 410 in the second network. In other words, the UDM/UDR 408 does not allow (or does not enable) a particular service in a network by not sending subscription data associated with the service to the AMF.

In various embodiments, if the UDM/UDR 408 determines to allow a service in the second network which is already used in the first network, the UDM/UDR 408 may send an update subscription (or registration) notification to the AMF1 406 to notify the AMF1 406 to terminate the service. The reason for termination may be that the service is not allowed or not subscribed.

In a thirteenth communication 448, the UDM/UDR 408 provides the UE 402 subscription data to the AMF2 410. The UDM/UDR 408 may include: 1) service restriction information; and 2) a request sent to the AMF2 410 to provide the registered S-NSSAIs in the second network (e.g., per access type). The service restriction information may be either an explicit indication or may be implicit (e.g., by not providing the subscription data for the corresponding service).

In a fourteenth communication 450, the AMF2 410 sends a registration accept to the UE 402. The AMF2 410 may in addition include services restriction information transmitted to the UE 402 based on the received services restriction from the UDM/UDR 408. For example, the registration accept message may contain an indication that a particular service (e.g., SMS) is not supported in the second network.

In a fifteenth communication 452, upon completion of the registration procedure with the UE 402, the AMF2 410 sends an update or notification to the UDM/UDR 408 to indicate the S-NSSAIs (e.g., S-NSSAI2) to which the UE 402 is successfully registered per access type.

The UDM/UDR 408 maintains 454 registration information for the UE 402 about which network slices are registered in which network (or AMF). Such information allows the UDM/UDR 408 to resolve requests about the UE's 402 serving NFs (e.g., AMF), where such requests are sent from requesting 5GC NFs (e.g., NEF, network slice specific authentication and authorization function (“NSSAAF”), PCF, and so forth).

For example, the information stored in the UDM/UDR 408 may be as follows: 1) the first network (e.g., identified by VPLMN1 ID or AMF1 ID)=S-NSSAI1, S-NSSAI3; and 2) the second network (e.g., identified by VPLMN2 ID or AMF2 ID)=S-NSSAI1, S-NSSAI2.

In a sixteenth communication 456, registration information may be used. A requesting NF (e.g., the NEF 411) may query the UDM/UDR 408 to resolve the serving NF (e.g., AMF), for a UE using S-NSSAI1. The UDM/UDR 408 uses 458 the information to resolve the serving AMF for S-NSSAI1 (e.g., the AMF1 406). The UDM/UDR 408 replies to the requesting NF (e.g., the NEF 411) the information that the AMF1 406 serves the UE 402.

In some embodiments, the UDM/UDR 408 may be able to maintain multiple registrations for the UE 402 with different networks for the same or different access types. In addition, the UDM/UDR 408 may be aware about the supported network slices by each network (e.g., which does not support all subscribed network slices of the UE 402). Also, the UDM/UDR 408 may determine a set of services to be used in each of the networks to which the UE 402 is allowed to register.

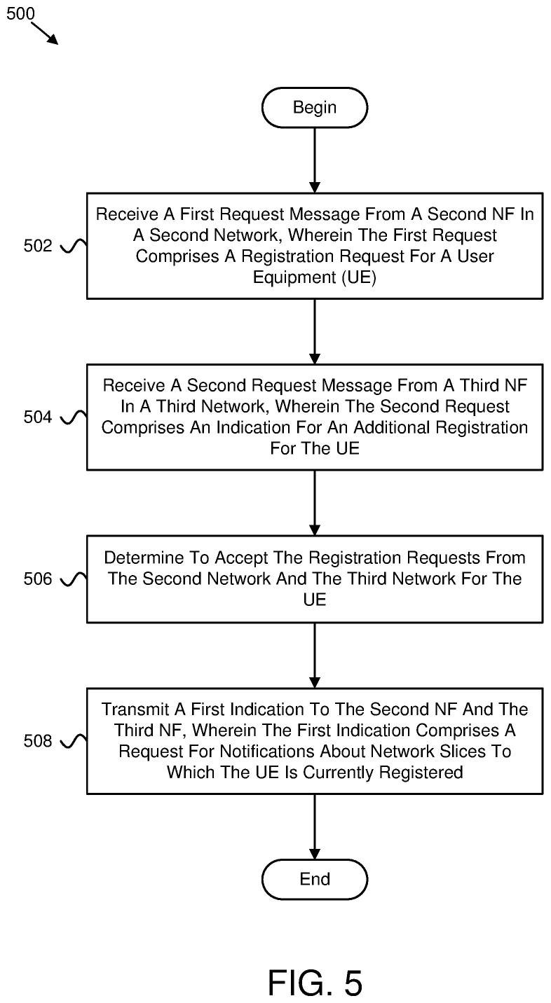

FIG. 5 is a flow chart diagram illustrating one embodiment of a method 500 for registering with multiple networks. In some embodiments, the method 500 is performed by an apparatus, such as the network unit 104. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502, at a first network function, a first request message from a second NF in a second network. The first request includes a registration request for a user equipment (UE). In some embodiments, the method 500 includes receiving 504 a second request message from a third NF in a third network. The second request includes an indication for an additional registration for the UE. In certain embodiments, the method 500 includes determining 506 to accept the registration requests from the second network and the third network for the UE. In various embodiments, the method 500 includes transmitting 508 a first indication to the second NF and the third NF. The first indication includes a request for notifications about network slices to which the UE is currently registered.

In certain embodiments, the method 500 further comprises transmitting a second indication to the second NF and the third NF, wherein the second indication comprises a first list of services that are allowed, a second list of services that are not allowed, or a combination thereof. In some embodiments, the method 500 further comprises determining which services are allowed, which services are not allowed, or a combination thereof in the second network, in the third network, or a combination thereof based on the network slices to which the UE registers in each of the second network and the third network. In various embodiments, the method 500 further comprises receiving notifications from the second NF and the third NF, wherein the notifications comprise a list of network slices to which the UE is currently registered.

In one embodiment, the method 500 further comprises storing an association for each of the second NF and the third NF indicating which network slices the UE is currently registered with in each of the second NF and the third NF. In certain embodiments, determining to accept the registration requests from the second network and the third network is based on a configuration in the first NF that: a specific network slice is supported in a specific network; the UE is authorized to use multiple simultaneous registrations to different networks for the same or different access types; or a combination thereof. In some embodiments, the first NF comprises a unified data management (UDM). In various embodiments, the second NF, the third NF, or a combination thereof comprises an access and mobility management function (AMF).

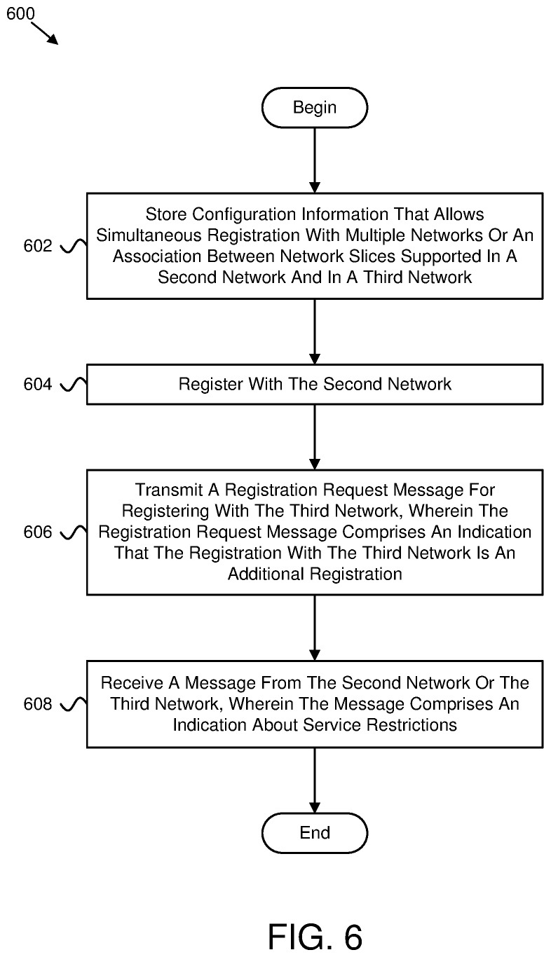

FIG. 6 is a flow chart diagram illustrating another embodiment of a method 600 for registering with multiple networks. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes storing 602, at a device, configuration information that allows simultaneous registration with multiple networks or an association between network slices supported in a second network and in a third network. In some embodiments, the method 600 includes registering 604 with the second network. In certain embodiments, the method 600 includes transmitting 606 a registration request message for registering with the third network. The registration request message includes an indication that the registration with the third network is an additional registration. In various embodiments, the method 600 includes receiving 608 a message from the second network or the third network. The message includes an indication about service restrictions.

In certain embodiments, the method 600 further comprises determining to register with the third network for using network slices not supported in the second network but supported in the third network. In some embodiments, the method 600 further comprises determining to include network slices in a requested network slice selection assistance information (NSSAI) associated with the third network. In various embodiments, the device comprises a user equipment (UE).

In one embodiment, a method of a first network function (NF) comprises: receiving a first request message from a second NF in a second network, wherein the first request comprises a registration request for a user equipment (UE); receiving a second request message from a third NF in a third network, wherein the second request comprises an indication for an additional registration for the UE; determining to accept the registration requests from the second network and the third network for the UE; and transmitting a first indication to the second NF and the third NF, wherein the first indication comprises a request for notifications about network slices to which the UE is currently registered.

In certain embodiments, the method further comprises transmitting a second indication to the second NF and the third NF, wherein the second indication comprises a first list of services that are allowed, a second list of services that are not allowed, or a combination thereof.

In some embodiments, the method further comprises determining which services are allowed, which services are not allowed, or a combination thereof in the second network, in the third network, or a combination thereof based on the network slices to which the UE registers in each of the second network and the third network.

In various embodiments, the method further comprises receiving notifications from the second NF and the third NF, wherein the notifications comprise a list of network slices to which the UE is currently registered.

In one embodiment, the method further comprises storing an association for each of the second NF and the third NF indicating which network slices the UE is currently registered with in each of the second NF and the third NF.

In certain embodiments, determining to accept the registration requests from the second network and the third network is based on a configuration in the first NF that: a specific network slice is supported in a specific network; the UE is authorized to use multiple simultaneous registrations to different networks for the same or different access types; or a combination thereof.

In some embodiments, the first NF comprises a unified data management (UDM).

In various embodiments, the second NF, the third NF, or a combination thereof comprises an access and mobility management function (AMF).

In one embodiment, an apparatus comprises a first network function (NF). The apparatus further comprises: a receiver that: receives a first request message from a second NF in a second network, wherein the first request comprises a registration request for a user equipment (UE); and receives a second request message from a third NF in a third network, wherein the second request comprises an indication for an additional registration for the UE; a processor that determines to accept the registration requests from the second network and the third network for the UE; and a transmitter that transmits a first indication to the second NF and the third NF, wherein the first indication comprises a request for notifications about network slices to which the UE is currently registered.

In certain embodiments, the transmitter transmits a second indication to the second NF and the third NF, wherein the second indication comprises a first list of services that are allowed, a second list of services that are not allowed, or a combination thereof.

In some embodiments, the processor determines which services are allowed, which services are not allowed, or a combination thereof in the second network, in the third network, or a combination thereof based on the network slices to which the UE registers in each of the second network and the third network.

In various embodiments, the receiver receives notifications from the second NF and the third NF, wherein the notifications comprise a list of network slices to which the UE is currently registered.

In one embodiment, the processor stores an association for each of the second NF and the third NF indicating which network slices the UE is currently registered with in each of the second NF and the third NF.

In certain embodiments, the processor determining to accept the registration requests from the second network and the third network is based on a configuration in the first NF that: a specific network slice is supported in a specific network; the UE is authorized to use multiple simultaneous registrations to different networks for the same or different access types; or a combination thereof.

In some embodiments, the first NF comprises a unified data management (UDM).

In various embodiments, the second NF, the third NF, or a combination thereof comprises an access and mobility management function (AMF).

In one embodiment, a method of a device comprises: storing configuration information that allows simultaneous registration with multiple networks or an association between network slices supported in a second network and in a third network; registering with the second network; transmitting a registration request message for registering with the third network, wherein the registration request message comprises an indication that the registration with the third network is an additional registration; and receiving a message from the second network or the third network, wherein the message comprises an indication about service restrictions.

In certain embodiments, the method further comprises determining to register with the third network for using network slices not supported in the second network but supported in the third network.

In some embodiments, the method further comprises determining to include network slices in a requested network slice selection assistance information (NSSAI) associated with the third network.

In various embodiments, the device comprises a user equipment (UE).

In one embodiment, an apparatus comprises a device. The apparatus further comprises: a processor that: stores configuration information that allows simultaneous registration with multiple networks or an association between network slices supported in a second network and in a third network; and registers with the second network; a transmitter that transmits a registration request message for registering with the third network, wherein the registration request message comprises an indication that the registration with the third network is an additional registration; and a receiver that receives a message from the second network or the third network, wherein the message comprises an indication about service restrictions.

In certain embodiments, the processor determines to register with the third network for using network slices not supported in the second network but supported in the third network.

In some embodiments, the processor determines to include network slices in a requested network slice selection assistance information (NSSAI) associated with the third network.

In various embodiments, the device comprises a user equipment (UE). Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. (canceled)

2. (canceled)

3. (canceled)

4. An apparatus for performing a first network function (NF), the apparatus comprising:
at least one memory; and
at least one processor coupled with the at least one memory and configured to cause the apparatus to:
receive a first request message from a second NF in a second network, wherein the first request comprises a registration request for a user equipment (UE);
receive a second request message from a third NF in a third network, wherein the second request comprises an indication for an additional registration for the UE;
determine to accept the registration requests from the second network and the third network for the UE; and
transmit a first indication to the second NF and the third NF, wherein the first indication comprises a request for notifications about network slices to which the UE is currently registered.

5. The apparatus of claim 4, wherein the at least one processor is configured to cause the apparatus to transmit a second indication to the second NF and the third NF, wherein the second indication comprises a first list of services that are allowed, a second list of services that are not allowed, or a combination thereof.

6. The apparatus of claim 4, wherein the at least one processor is configured to cause the apparatus to determine which services are allowed, which services are not allowed, or a combination thereof in the second network, in the third network, or a combination thereof based on the network slices to which the UE registers in each of the second network and the third network.

7. The apparatus of claim 4, wherein the at least one processor is configured to cause the apparatus to receive notifications from the second NF and the third NF, wherein the notifications comprise a list of network slices to which the UE is currently registered.

8. The apparatus of claim 7, wherein the at least one processor is configured to cause the apparatus to store an association for each of the second NF and the third NF indicating which network slices the UE is currently registered with in each of the second NF and the third NF.

9. The apparatus of claim 4, wherein the at least one processor is configured to cause the apparatus to determine to accept the registration requests from the second network and the third network is based on a configuration in the first NF that:
a specific network slice is supported in a specific network;
the UE is authorized to use multiple simultaneous registrations to different networks for the same or different access types;
or a combination thereof.

10. The apparatus of claim 4, wherein the first NF comprises a unified data management (UDM).

11. The apparatus of claim 4, wherein the second NF, the third NF, or a combination thereof comprises an access and mobility management function (AMF).

12. A user equipment (UE), the comprising:
at least one memory; and
at least one processor coupled with the at least one memory and configured to cause the UE to:
store configuration information that allows simultaneous registration with multiple networks or an association between network slices supported in a second network and in a third network;
register with the second network;
transmit a registration request message for registering with the third network, wherein the registration request message comprises an indication that the registration with the third network is an additional registration; and
receive a message from the second network or the third network, wherein the message comprises an indication about service restrictions.

13. The UE of claim 12, wherein the at least one processor is configured to cause the UE to determine to register with the third network for using network slices not supported in the second network but supported in the third network.

14. The UE of claim 12 or 13, wherein the at least one processor is configured to cause the UE to determine to include network slices in a requested network slice selection assistance information (NSSAI) associated with the third network.

15. (canceled)

16. A processor for wireless communication, comprising:
at least one controller coupled with at least one memory and configured to cause the processor to:
store configuration information that allows simultaneous registration with multiple networks or an association between network slices supported in a second network and in a third network;
register with the second network;
transmit a registration request message for registering with the third network, wherein the registration request message comprises an indication that the registration with the third network is an additional registration; and
receive a message from the second network or the third network, wherein the message comprises an indication about service restrictions.

17. The processor of claim 16, wherein the at least one controller is configured to cause the processor to determine to register with the third network for using network slices not supported in the second network but supported in the third network.

18. The processor of claim 16, wherein the at least one controller is configured to cause the processor to determine to include network slices in a requested network slice selection assistance information (NSSAI) associated with the third network.

19. A method performed by a user equipment (UE), the method comprising:
storing configuration information that allows simultaneous registration with multiple networks or an association between network slices supported in a second network and in a third network;
registering with the second network;
transmitting a registration request message for registering with the third network, wherein the registration request message comprises an indication that the registration with the third network is an additional registration; and
receiving a message from the second network or the third network, wherein the message comprises an indication about service restrictions.

20. The method of claim 19, further comprising determining to register with the third network for using network slices not supported in the second network but supported in the third network.

21. The method of claim 19, further comprising determining to include network slices in a requested network slice selection assistance information (NSSAI) associated with the third network.
